(19) United States
(12) Patent Application Publication
(10) Pub. No.: US 2016/0209594 A1
(43) Pub. Date: Jul. 21, 2016

(54) SYSTEM AND METHOD FOR LINEAR NON-RECIPROCAL COMMUNICATION AND ISOLATION

(71) Applicant: The Board of Trustees of the University of Illinois, Urbana, IL (US)

(72) Inventor: Gaurav Bahl, Urbana, IL (US)

(73) Assignee: The Board of Trustees of the University of Illinois, Urbana, IL (US)

(21) Appl. No.: 14/995,768

(22) Filed: Jan. 14, 2016

Related U.S. Application Data
(60) Provisional application No. 62/104,391, filed on Jan. 16, 2015.

(51) Int. Cl. G02B 6/293; G10K 11/18; H01P 1/219

(52) U.S. Cl. CPC G02B 6/29341; H01P 1/219; G10K 11/18

(57) ABSTRACT

A system and method includes a waveguide for guiding an energy received from a laser. A resonator couples with the waveguide. A signal generator (pump) generates a spatiotemporal pattern wave in the resonator. The spatiotemporal pattern wave produces a wave interaction. Where an interaction between the signal, the spatiotemporal pattern wave and the wave interaction produce linear non-reciprocal behavior in the signal wave.

### CROSS-REFERENCE TO RELATED APPLICATION

This application claims the benefit of U.S. Provisional Application Ser. No. 62/104,391, filed Jan. 16, 2015, which is incorporated in its entirety herein.

### GOVERNMENT LICENSE RIGHTS

This invention was made with government support under grant number ECCS-1408539 awarded by the US National Science Foundation (NSF), and grant number FA9550-14-1-0217 awarded by the US Air Force Office for Scientific Research (AFOSR). The government has certain rights in the invention.

### BACKGROUND

Breaking time reversal symmetry, e.g., non-reciprocity, is necessary for optical isolators and circulators, e.g., in the context of chip-scale optical communications, amplifiers, and sensors. Presently, non-reciprocal optical devices, such as isolators and circulators, are almost exclusively built using the Faraday polarization rotation effect. The Faraday effect is a magneto-optical phenomenon through which direction-asymmetric polarization rotation can be achieved in materials biased by a magnetic field. Example materials used for optical isolators and circulators are garnets (Terbium Gallium Garnet, Yttrium Iron Garnet) as they are optically transparent in the wavelength ranges of interest and have a high Faraday rotation effect in response to a magnetic field. Dynamic optical non-reciprocity has also been achieved through optically-pumped Brillouin scattering and through electrically-driven interband transitions, but these are nonlinear effects requiring subsequent optical filtering.

### BRIEF DESCRIPTION OF THE DRAWINGS

In association with the following detailed description, reference is made to the accompanying drawings, where like numerals in different figures can refer to the same element.

FIG. 1 is a block diagram of prior Faraday rotation isolators that operate through non-reciprocal polarization rotation under bias magnetic field (M) followed by polarization filtering.

FIGS. 2A-C include graphs of phase-matched traveling-wave phonon-photon interaction in bulk materials (Brillouin Scattering).

FIGS. 3A-B and FIG. 4 include triply-resonant Brillouin coupling within microresonators.

FIGS. 5A-F include graphs of examples for Brillouin scattering induced transparency (BSIT).

FIG. 6 is a graph of an energy-momentum diagram where non-reciprocal optical transmission controlled by traveling acoustic phonons is predicted.

FIG. 7 is a graph of an example of optically-controlled non-reciprocal BSIT in an ultra-high-Q silica resonator.

FIG. 8 includes graphs of an example prediction of MHz-bandwidth linear optical isolation achievable through traveling acoustic phonon stimulus.

FIGS. 9A-C are diagrams of example electro-opto-mechanical resonator systems through which nonreciprocal optical isolation can be achieved.

FIG. 10 is a block diagram of an example circulator configuration.

FIG. 11 is an example isolator.

### DETAILED DESCRIPTION

Reciprocity, or time-reversal symmetry, is an inescapable property in electromagnetic, acoustic, and thermodynamic systems. In the optical context, non-reciprocal behavior can be obtained using magneto-optical effects. An example of non-reciprocal behavior is to allow light to travel forwards but not backwards in a waveguide—such a device is called an “isolator”. Until now, however, this requires the use of specialized magneto-optic materials that are challenging to implement at the chip-scale, and biasing magnetic fields that are not suitable for many applications. Previously studied magnet-free alternatives for non-reciprocity are either intrinsically not linear or are experimentally unproven. It is desirable to achieve magnet-free nonreciprocity with optical or acoustic or electronic control.

The systems and methods relate to traveling-wave Brillouin scattering induced optical interference mechanism that can be used to achieve linear non-reciprocal behavior. Isolators and circulators could then be manufactured with nearly any optoelectronic material, e.g., glass, at any wavelength of choice. The systems and methods utilize a traveling wave acousto-optic coupling obtained through Brillouin scattering coupling of light and sound waves in resonators. The Brillouin scattering coupling between light and sound occurs through photoelastic scattering and optical electro-striction pressure. In another example, an electronic signal wave and light wave could be coupled through wave-like electronic excitations or excitons, etc. Under suitable conditions, this coupling leads to the appearance of a transparency in the resonator optical modes. The transparency can be turned on and off using an optical field called the “pump”. This transparency is non-reciprocal because it only appears for light propagating in one direction. By replacing the optical pump with an acoustic pump, e.g., speaker or other sound generator, to stimulate the sound wave directly, wide bandwidth linear non-reciprocity is achievable. A non-magnetic system can be used for non-reciprocal photon scattering and quantum information storage processes, and also for implementing on-chip linear isolators and circulators. The system eliminates the need for specialized materials or magnetic fields to control nonreciprocity. Several disruptive technologies for phonon- and photon-controlled optical signal routing, timing, and sensing can be enabled.

The systems and methods can provide a non-reciprocal mechanism based on the electromagnetically induced transparency (EIT)-like resonant interference between two coupled optical modes of a resonator, mediated through Brillouin scattering from a third traveling-wave acoustic mode of the device. In contrast to EIT, this mechanism is intrinsically non-reciprocal due to the momentum conservation requirements.

The systems and methods can provide efficient magnet-free on-chip optical isolators and circulators built in nearly any transparent optical material, and can reduce the cost and complexity of on-chip non-reciprocal devices for signal routing. A circulator device can then be dynamically switched on and off through control of the optical or acoustic excitation, depending on how it is implemented. Such non-reciprocal devices are used for protecting lasers from back-reflections, minimizing mode competition and parasitic effects. The systems and methods can be used for cold-atom sensors, chip-scale atomic clocks, and other systems where background magnetic fields are undesirable.

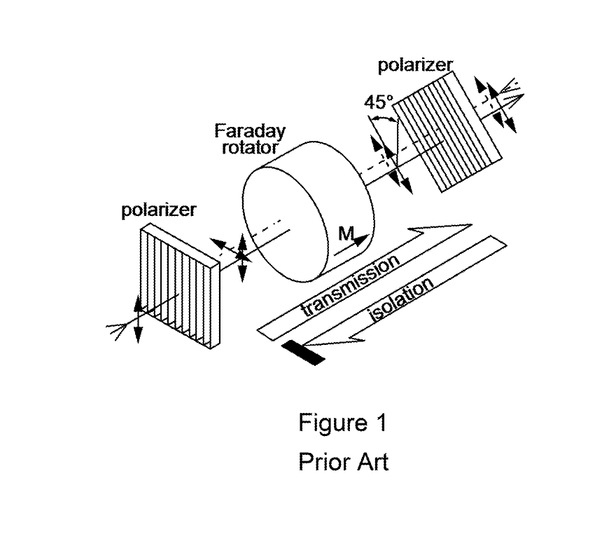

FIG. 1 is a block diagram of a prior Faraday rotation isolator that operates through non-reciprocal polarization rotation under bias magnetic field (M) followed by polarization filtering. Faraday effect isolators operate by rotating the plane of polarization of a linearly polarized electromagnetic wave. Light propagating through a wave plate made of conventional optical materials experiences a certain angle polarization rotation independent of the propagation direction. In Faraday rotation, however, a forward propagating wave experiences a polarization rotation through an angle opposite to a backward propagating wave. As a consequence, the returning optical field can be filtered by polarization selection or through a birefringent filter. Optical circulators are used for observing backscattered or reflected optical signals in many systems. Circulators are similar to isolators, except signals in the return direction are routed to a third port instead of being eliminated through spatial or polarization filtering. Other devices that can benefit from the systems and methods include phase shifters, optical switches, etc. These optical devices can be used for optical communications.

Recent technological advances in chip-scale photonics are enabling devices for on-chip optical communications, photonic sensors for physical and biological applications, cold-atom devices, inertial sensors, and rotation sensors. For the purpose of laser source protection and signal routing, making non-reciprocal technologies available at the chip-scale and expanding the material selection are challenging. The integration of materials with strong Faraday rotation effect and built-in magnetic polarization is costly and requires special materials and processing, making on-chip implementation of these off-chip techniques problematic. Using conventional optoelectronic materials can be preferable. Magnet based Faraday rotation optical isolators are thus challenging to implement on-chip as they require the integration of ferrites and also magnetic materials to supply the biasing fields, and have high loss. Magneto-optic non-reciprocal devices cannot be dynamically switched unless electromagnets are employed, which add a significant power consumption requirement. A non-magnetic alternative is desirable.

In the context of on-chip optical non-reciprocity several fundamental science and engineering challenges can be identified. Biasing magnetic fields and magneto-optic effects are undesirable in several applications. For instance, chip-scale atomic clocks, magneto-optic traps, cold-atom sensors can be adversely affected by magnetic fields. Local confinement of biasing magnetic fields in a small part of an optical chip can be challenging, and such unconfined fields can affect adjacent devices. A magnet-free optical isolation method thus carries extremely high impact.

Magnet-free approaches for achieving optical non-reciprocity have been proposed in the past. These include angular momentum biasing, opto-mechanical effects, electro-optic interband transitions, acousto-optic scattering, and helicity sensitive transitions. Very few experimental demonstrations of such systems exist. Achieving linear non-reciprocity is fundamentally not possible with several of these techniques. A “linear” nonreciprocal device performs the same function irrespective of signal strength, and does not modify the signal wavelength or frequency or mode.

Momentum-based selection processes can be used to achieve direction dependent non-reciprocity in optical systems in the following way. Spatiotemporal modulation of photonic structures can be used to impart both frequency and momentum shifts, resulting in interband photonic transitions that are propagation direction dependent. Using electro-optic modulation, up to 3 dB of electrically-driven optical isolation has been previously shown through such transitions. However, these methods are inherently nonlinear, i.e. they cause mode and frequency shifts, and need to be combined with a filter.

Magnet-free isolation by using traveling wave light-sound interactions (Brillouin scattering), which also result in interband transitions, has been proposed in highly nonlinear fiber systems. It can be, however, a weak effect requiring long propagation distances to be observable. The efficiency of Brillouin scattering processes can be improved through high-power optical pumping, but is still challenging to implement on-chip due to the device length requirements and thermal management issues. In addition, the non-reciprocity effect is nonlinear, e.g., in one direction the input signal is unperturbed while in the opposite direction the input signal is frequency-shifted or mode-shifted. Filtering is thus used to eliminate the scattered light, but separating 200 THz optical signals separated by 100 MHz-1 GHz acoustic frequencies can be an extremely challenging task. As discussed below, high-Q resonances naturally improve the selectivity and efficiency of these acousto-optical phenomena.

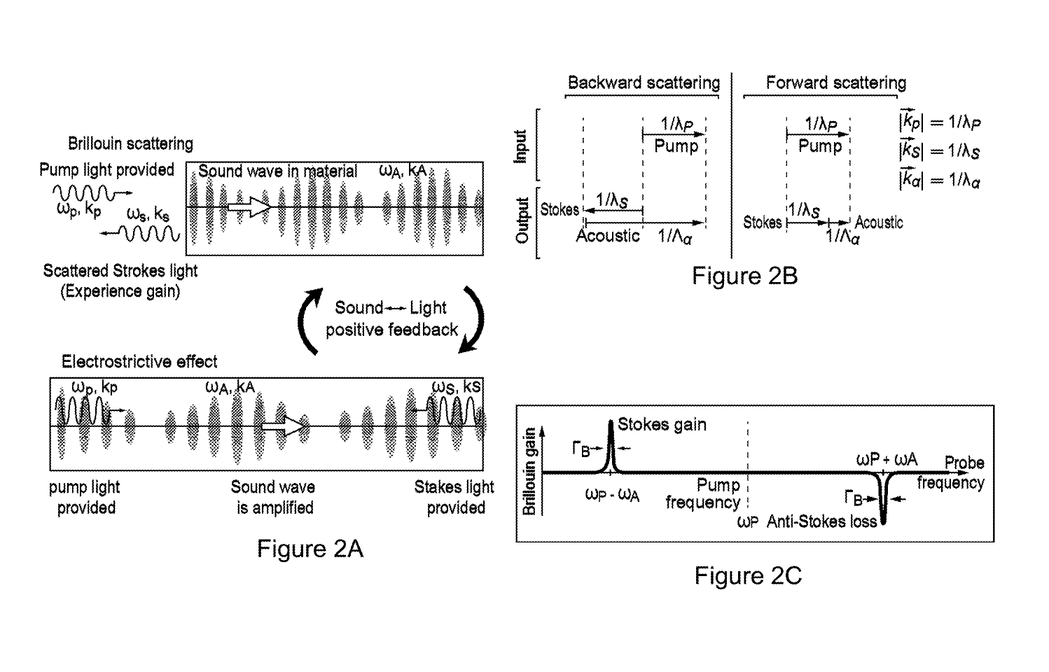

FIGS. 2A-C include graphs of phase-matched traveling-wave phonon-photon interaction in bulk materials (Brillouin Scattering). In FIG. 2A electrostriction induced by spatio-temporal overlap of two optical fields amplifies an acoustic wave, or other spatiotemporal pattern stimulus, (phonon mode) in a material, while photoelastic scattering from the acoustic wave provides optical positive feedback. In FIG. 2B, both forward scattering and backward scattering are allowed. The wavevector conservation (e.g. momentum conservation) for Stokes scattering is illustrated in terms of inverse wavelength. In FIG. 2C, in a pump-probe configuration, a secondary probe signal (Stokes or anti-Stokes) experiences gain or loss depending on the offset frequency relative to the pump, in turn amplifying or attenuating the phonon mode.

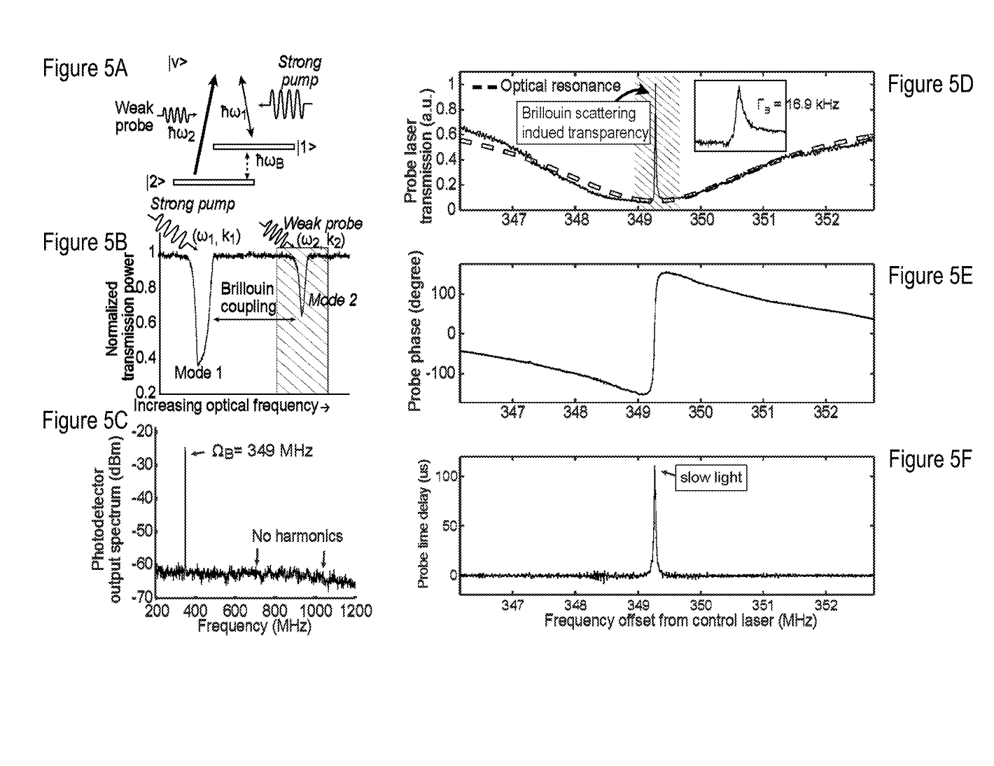

The traveling-wave interaction between two optical waves (light) and one propagating acoustic wave is broadly termed as Brillouin scattering and is one of the strongest nonlinearities in optics. In the process, input light at one optical frequency scatters from the photoelastic perturbation caused by the acoustic wave to the second optical frequency. Simultaneously, the two optical fields (input and scattered field) generate an electrostrictive pressure that either reinforces or attenuates the acoustic wave, depending on Stokes (to lower frequency) or anti-Stokes (to higher frequency) scattering. This occurs as long as the “phase-matching” conditions representing momentum and energy conservation between the light waves and sound wave are satisfied (FIG. 6). If there is no optical mode available to accept the scattered light, however, no interaction takes place.

Brillouin scattering is the photoelastic scattering of light from propagating acoustic waves in a material, and is one of the strongest known nonlinearities in optics. Acoustic phonons scatter and Doppler-shift the input “pump” light ωₚ into a new red-shifted “Stokes” optical signal ω, or a blue-shifted “anti-Stokes” optical signal ωₐₛ. Here, a light-matter quantum event has taken place in which a photon at ωₚ is annihilated, while a photon at ωₛ (or ωₐₛ) and an acoustic phonon at ωₐ=ωₚ−ωₛ (or ωₐ=ωₐₛ−ωₚ) is created (or annihilated). The creation or annihilation of these acoustic phonons takes place through electrostriction forces generated by interference between the pump and scattered light. When the input light is sufficiently intense and sufficient path length through the medium is available, the Brillouin scattering process can take on a stimulated nature where light itself creates the sound wave through the process of electrostriction, and is called Stimulated Brillouin Scattering (SBS), FIG. 2a. The strength of feedback is determined by the electrostriction coefficient of the material, in conjunction with other parameters. In Brillouin systems, a probe optical signal at the Stokes offset frequency experiences gain, and loss is experienced at the anti-Stokes offset frequency (FIG. 2C).

While the above frequency relations only describe energy conservation for this process, momentum conservation is essential as well (see FIG. 2B) due to the traveling wave nature of the interaction. Here, the momentum of the input ‘pump’ light (\vec{k}ₚ), the scattered Stokes light (\vec{k}ₛand the acoustic wave (\vec{k}ₐ) must obey \vec{k}ₚ=\vec{k}ₛ+\vec{k}ₐ. Similarly, for anti-Stokes scattering, \vec{k}ₚ=\vec{k}ₐₛ−\vec{k}ₐ holds true. Such scattering of light can indeed take place in any direction e.g. forwards or backwards (see FIG. 2B). The forward scattering processes provide access to phonon modes with long lifetimes, enabling the Brillouin anti-stokes process, and the generation of Brillouin Scattering Induced Transparency (BSIT) which is used for generating the non-reciprocity. It is the momentum conservation that can provide the intrinsic non-reciprocity of Brillouin scattering phenomena.

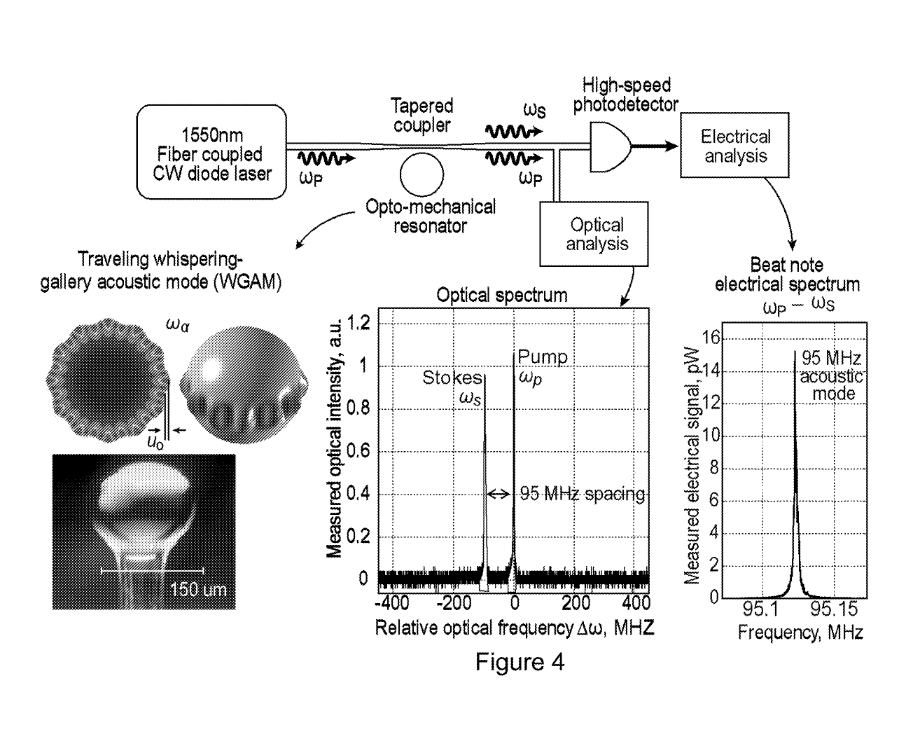

EIT is a powerful mechanism for controlling light propagation in a dielectric medium, e.g., dielectric waveguide, or a microstrip waveguide or other form of waveguide. EIT traditionally arises from destructive interference induced by a nonradiative coherence in an atomic system. A strong ‘control laser’ induces a transparency window for a weak ‘probe laser’ at a different wavelength, due to two interfering excitation pathways in a 3-level atomic system (FIG. 5A). The opening of the transparency window also creates a large change in the group index in that region, resulting in a dramatic slowing or speeding up of the group velocity of light in the transparency region (‘slow’ and ‘fast’ light).

Photon modes and phonon modes can be strongly-coupled in high-Q resonators through centrifugal radiation pressure, photothermal pressure, and gradient force. This enables an optical interface to high frequency mechanical oscillations spanning MHz-GHz frequencies. Extensive research has been performed on extending analogies from atomic-level effects, such as cooling, quantum phenomena, and induced transparency effects to these opto-mechanical cavities. Processes analogous to EIT have also been demonstrated in optomechanical systems, in which resonant optical modes interfere through a coherent vibrational mechanical mode. These are termed as Optomechanically Induced Transparency (OMIT). Since OMIT does not rely on naturally occurring atomic or material resonances it can be applied at practically any wavelength that may be of interest (e.g. the process is phase matched for all optical wavelengths). The mechanical vibrations are standing-wave breathing eigenmodes of the device and can thus be engineered. OMIT has recently been employed in quantum information storage schemes and for generating slow and fast light.

Brillouin scattering light-sound interaction has also been used successfully for the generation of slow and fast light. However, EIT-type transparency processes based on Brillouin scattering were considered infeasible because of the short coherence lifetime of hypersonic phonons. A demonstration of the Brillouin Scattering Induced Transparency (BSIT) can be achieved through forward-scattering acousto-optic interaction of light with long-lived propagating phonons in a silica resonator.

Nonlinear optical processes such as EIT need to satisfy the energy-momentum conservation, leading to the phase-matching requirement. For EIT in an atomic system, the momentum of the spin wave is set by the relevant optical waves, automatically satisfying the phase matching requirement. In comparison, the traveling acoustic wave in BSIT carries a momentum that is intrinsic to the mechanical medium, is discretized by the resonator, and can far exceed the momentum of an optical wave, which leads to special phase matching requirement. This unique property makes BSIT intrinsically non-reciprocal.

Since OMIT takes place via stationary breathing vibrational modes, instead of traveling acoustic wave modes as in BSIT, OMIT lacks the special momentum-conserving phase matching and non-reciprocity characteristic of BSIT. Indeed it has been theoretically suggested that optomechanical systems can exhibit non-reciprocity, however such a phenomenon has not been experimentally demonstrated.

Magnet-free isolation by using traveling wave light-sound interactions such as Brillouin scattering has been proposed before in nonlinear waveguide systems, but has proven challenging to implement on-chip due to low efficiency, and high power and device length requirements. There is a need to improve the efficiency of these processes through resonance. Brillouin scattering acousto-optic systems require optical pumping to control the non-reciprocal interaction. Electronic or acoustic control can be desirable. Linear non-reciprocity is desirable: The Brillouin acousto-optic method relies on frequency shifting the input optical field to another frequency which places additional filtering requirements.

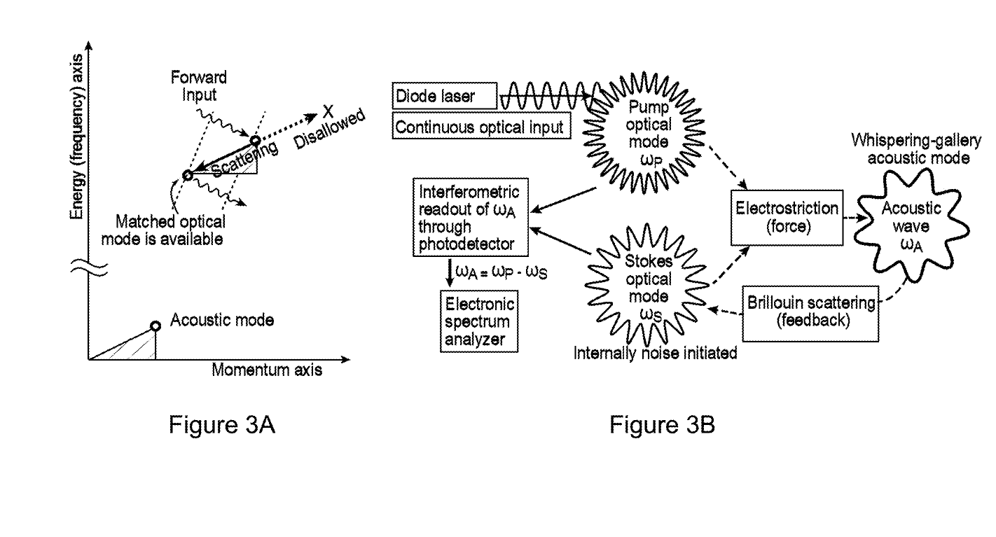

FIGS. 3A-B and FIG. 4 include triply-resonant Brillouin coupling within microresonators. In FIG. 3A whispering gallery resonators (WGR) discretize the available optical and mechanical modes, which are indicated here by the discrete circles on the ω-k diagram. An optical input wave can scatter into a suitable Stokes (lower frequency) optical mode when the energy and momentum difference matches the associated acoustic mode (indicated by the triangles). In this picture anti-Stokes scattering is forbidden since the resonator modes are from different modal families and are not periodic. In FIG. 3B, the resonant coupling of the optical and acoustic modes is illustrated in a WGR. In FIG. 4, an example setup is illustrated of noise-initiated Stokes amplification and oscillation in a silica WGR.

Using the Brillouin scattering mechanism continuous-wave laser light can be used to stimulate traveling acoustic waves in WGRs with very high transduction efficiency. As described in FIGS. 3A-B and FIG. 4, forward Brillouin scattering of light from thermally-excited phonons is coupled with electro-strictive feedback, resulting in the coherent amplification of the phonon mode. Resonant whispering-gallery acoustic modes in the 10 MHz-1.4 GHz regime can thus be actuated. For example, light from the input “pump” laser ωₚ is evanescently coupled to a whispering-gallery optical mode of the WGR by means of an optical coupler, e.g. a tapered optical fiber. The acoustic vibration can be measured by means of temporal interference between the pump ωₚ and scattered Stokes ω, optical signals on a photodetector.

FIGS. 5A-F include graphs of examples for Brillouin scattering induced transparency (BSIT). In FIG. 5A, BSIT is enabled in Brillouin scattering coupled lambda-type systems. In an energy level visualization of anti-Stokes Brillouin scattering the transition |2 [symbol] →|v [symbol] interferes with transition |2 [symbol] →|v [symbol] →|1 [symbol] →|v [symbol] generating a transparency in the optical mode. In FIG. 5B, the lower optical mode is pumped with a strong laser, while weakly probing the upper mode. In FIG. 5C, Brillouin phase matching is confirmed with a Stokes scattering experiment. In FIG. 5D, BSIT is observed within the probe optical mode and also exhibits FIG. 5E a strong dispersion response indicating FIG. 5F extremely efficient slow light.

A Brillouin scattering induced transparency (BSIT) can occur within the optical modes of silica microresonators. The process is observed by measuring Brillouin phase-matched optical modes through a pump-probe experiment (FIG. 5B). BSIT occurs in systems of optical modes that are coupled through a Brillouin scattering interaction, provided that the phonon mode has a long coherence lifetime.

In an energy level visualization (FIG. 5A), the probe optical transition from |2 [symbol] →|v [symbol] interferes with |2 [symbol] →|v [symbol] →|1 [symbol] →|v [symbol] in a manner similar to EIT. Traditionally, an optical field interacting with a mode of a resonator experiences very strong absorption within the optical resonance bandwidth (FIG. 5B). However, the presence of a strong optical pump on the low-frequency optical mode induces a transparency for the higher-frequency probe mode due to the triply-resonant traveling wave interaction (FIG. 5D). In other words, the probe signal absorption is inhibited, resulting in greater transmission through the otherwise absorbing optical mode.

The quantum interference description is nonessential for describing acousto-optic transparency phenomena. A classical, analytical description of BSIT can be used, e.g., adopted from the mathematical formalism established by G. S. Agarwal and Sudhanshu S. Jha entitled “Multimode phonon cooling via three-wave parametric interactions with optical fields,” Physical Review A, 88(1):013815, July 2013, which is incorporated by reference herein. The intracavity fields representing the pump/control laser, anti-Stokes shifted probe, and acoustic displacement can be described using the following coupled rate equations.

\dot{α}₁=−γ₁α₁−iβ*u*α₂+hd f_{ForwardOpticalPump}

\dot{α}₂=−γ₂α₂−iβuα₁+f_{ForwardOpticalProbe}

\dot{u}=−γ_{B}u−iβ*α₁*α₂ (1)

where α₁, α₂, and u are the slowly varying phasor amplitudes of intracavity control field, scattered light field, and mechanical displacement respectively, γ₁, γ₂ are the optical loss rates of pump mode and anti-Stokes probe mode respectively, γ_{B} is acoustic loss rate, and β is the coupling coefficient accounting for modal overlap and Brillouin gain in the material. The f₁ terms are the optical inputs provided. For simplicity here assume that the three fields are on resonance with the respective modes. A complete analysis is provided in JunHwan Kim, Mark C Kuzyk, Kewen Han, Hailin Wang, and Gaurav Bahl entitled “Non-Reciprocal Brillouin Scattering Induced Transparency,” Nature Physics 11, pp.275-280, doi:10.1038/nphys3236, 2015, which is incorporated by reference herein. These equations produce the steady state amplitudes of the fields:

$${a}_{1} = \frac{{f}_{c}}{{γ}_{1}} \\ {a}_{2} = \frac{{f}_{p} {γ}_{B}}{{γ}_{2} {γ}_{B} + {\vert β \vert}^{2} {\vert {a}_{1} \vert}^{2}} \\ u = \frac{- i {β}^{*} {a}_{1}^{*} {a}_{2}}{{γ}_{B}} \qquad ( 2 )$$

The probe laser intracavity response a₂ can then be analyzed for the transparency phenomenon.

The modification to the optical dispersion for field α₂ is visible in the denominator of (2), which indicates magnitude and group velocity perturbations (slow and fast light). Previous Brillouin scattering slow/fast light research efforts have been limited to the lossy phonons at around 10 GHz frequency. In contrast, this result involves phonons of lower frequency (100 -300 MHz) that have longer lifetimes (approaching 0.1 ms).

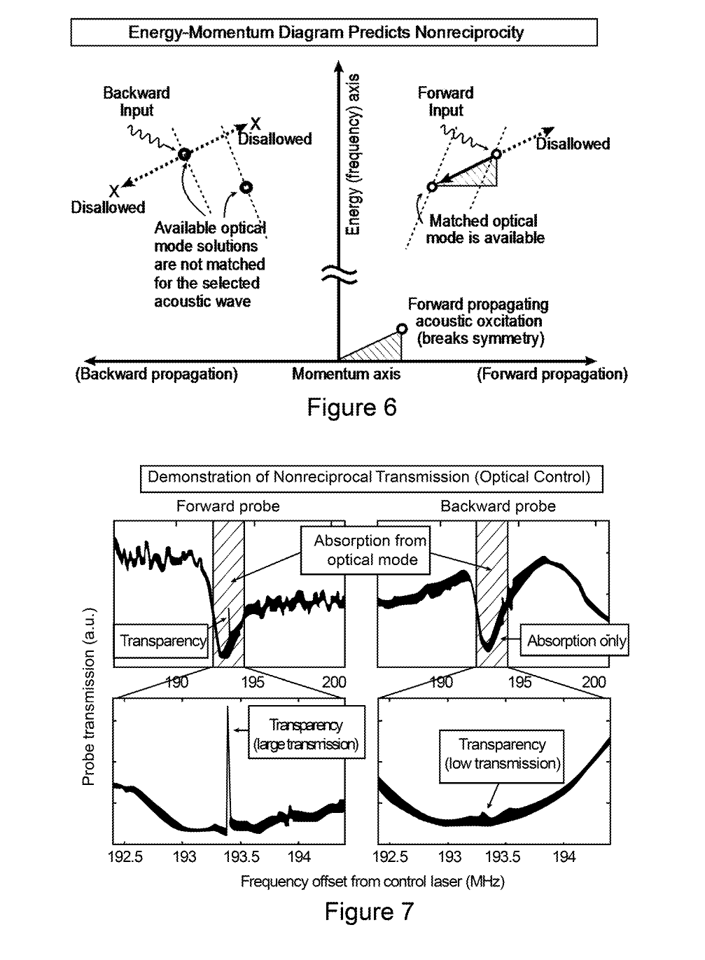

FIG. 6 is a graph of an example prediction of optically-controlled non-reciprocal transmission. A phase matching diagram (similar to FIG. 3A) shows the conditions encountered by forward and backward propagating optical modes within a Brillouin coupled resonator system. Circles indicate resonator modes. The triangle indicates the energy and momentum of the acoustic wave. The discrete resonator modes have directional mirror symmetry around the origin. However, the driven acoustic wave direction dictates the optical wave directions for the Brillouin interaction to take place. Thus, only forward propagating optical signals experience the Brillouin scattering interaction with this acoustic wave. Backward signals pass through without interaction, resulting in an inherent directional non-reciprocity. This non-reciprocity is probed in FIG. 7.

Co-propagation of the three waves satisfies the phase matching conditions for this triply-resonant scattering process (FIG. 6). Even though the optical modes are symmetric, the process symmetry is broken because of the energy and momentum imparted by the unidirectional acoustic wave. If the probe laser field propagates in the backward direction (e.g. is time-reversed), phase matching with the specific acoustic wave is not satisfied and no interaction takes place. This leads to a direction-dependent non-reciprocal transparency as demonstrated in FIG. 7.

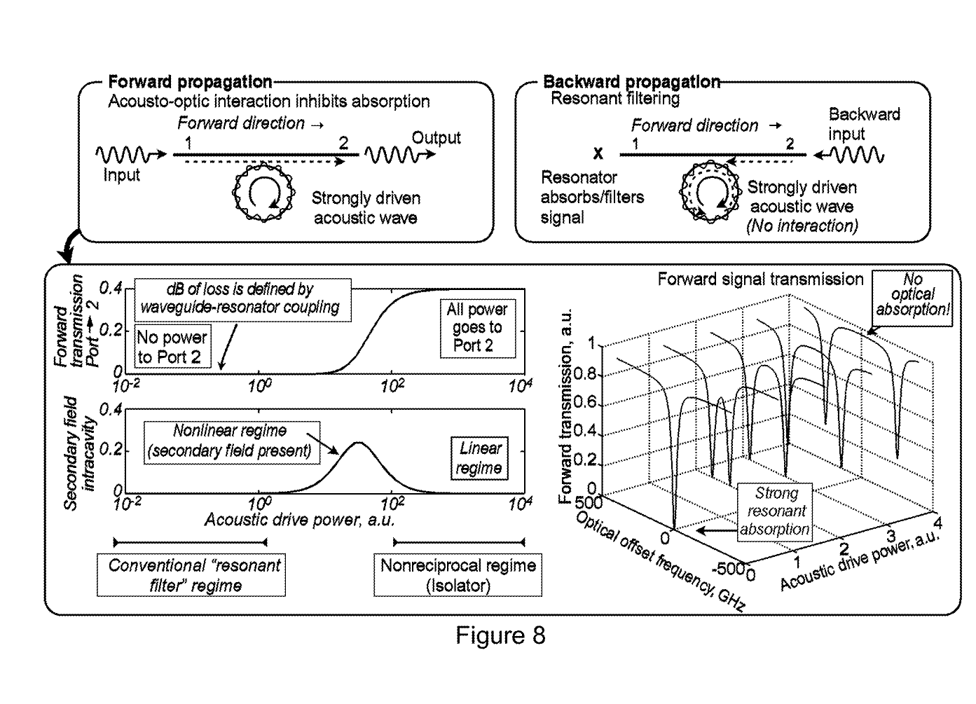

FIG. 7 is a graph of an example of optically-controlled non-reciprocal BSIT in an ultra-high-Q silica resonator. A forward traveling optical signal sees approximately 20 kHz bandwidth transparency within the optical absorption, while a backward propagating signal experiences strong absorption. This result is explained in FIG. 6. MHz-GHz scale bandwidth can be achieved with acoustic control as shown in FIG. 8.

The classical rate equation approach used to explain BSIT (Eqns. 1 and 2) is established in the field of opto-mechanics. While the process can be described through a quantum interference approach if desired, the classical wave interference description explains all observed phenomena and is physically correct. In the context of BSIT, observed slow/fast light phenomena, optical transmission functions, and Fano-like transparency resonances, are accurately captured by these equations.

Acoustic control can supplant optical control for achieving non-reciprocal transmission in common optoelectronic materials due to intrinsic symmetry of the BSIT equations. No special materials or magneto-optic effects are needed. With acoustic control, the nonreciprocal bandwidth can be expanded to cover several MHz-GHz. Such a result is sufficient for isolating narrow linewidth laser from back-reflections and many other practical applications.

An acoustic-pumped non-reciprocal scattering process is described in relation to optical pumping. The optical pump used in BSIT can be replaced by an acoustic pump represented as a resonant traveling acoustic wave as in FIG. 3A-F. This is possible because of the symmetry inherent in the system equations (Eqns. 1) as discussed below. By removing the optical pump, and replacing it with an different pump, e.g. acoustic or sound wave, electron wave or other spatiotemporal modulator to modulate the device in a particular pattern, the need for a second laser field to control the process can be eliminated, and a significantly improved power efficiency can be achieved for on-chip applications, e.g., with larger bandwidth. Such an acoustic field (e.g. resonant traveling acoustic wave) can be actuated using the techniques developed for MEMS devices such as piezoelectric or electrostatic actuation. As described below, the acoustic drive also broadens the bandwidth over which non-reciprocity occurs. A regime of operation can be predicted where the system becomes linear, e.g. no nonlinear optical scattering takes place.

The optically pumped isolation effect works over about a narrow 20 kHz bandwidth as demonstrated in FIG. 7. The symmetry inherent to the three coupled rate equations (Eqns. 1) that model BSIT can be exploited beneficially. In the transparency case, pump one optical field strongly and observe the acoustic-coherence BSIT by probing the second optical mode. By pumping the acoustic field instead, such as through a MEMS piezoelectric or electrostatic actuation method, a stronger optical effect can be extended over a wider bandwidth. To demonstrate this analytically, employ the same system of equations (Eqns. 1) and replace the strong optical ‘pump’ with an acoustic drive instead, as shown here (symbols carry same meaning as before).

\dot{α}₁=−γ₁α₁−iβ*u*α₂

\dot{α}₂=−γ₂α₂−iβuα₁+f_{ForwardOpticalProbe}

\dot{u}=−γ_{B}u−iβ*α₁*α₂+f_{AcousticDrive} (3)

The result for forward propagation of optical field α₂ (the input Probe field) through the system is shown in FIG. 8.

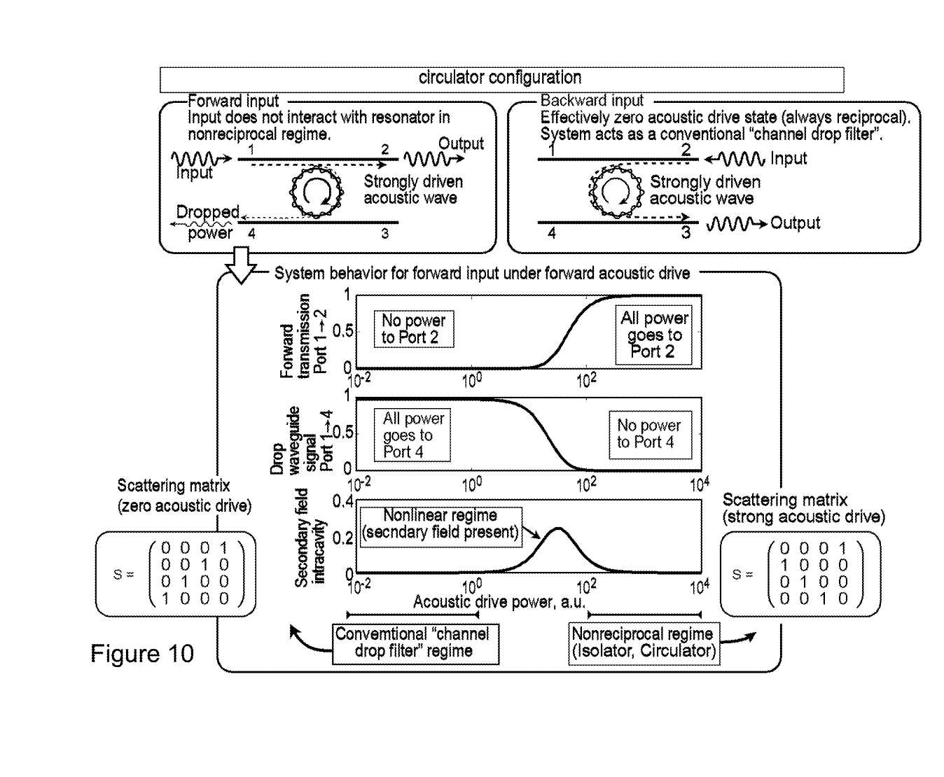

FIG. 8 includes graphs of example MHz-GHz bandwidth linear optical isolation. By employing a strong acoustic drive, as modeled by Eqns. 3, optical isolation can be achieved over the entire optical mode bandwidth. Increasing acoustic drive power (Bottom-right) makes the optical resonance split in the forward direction (Top-left), turning the near-complete absorption to near-100% transmission at the center wavelength (Bottom-left). In the backward direction (Top-right), only the absorption due to the optical mode can be seen. Thus, the forward signal propagates unhindered while the backward signal is absorbed. The light in the scattered frequency-shifted optical mode (Bottom-left) is plotted as a function of acoustic driving. This light disappears in the case of very strong acoustic drive, resulting in a completely linear optical isolation effect. This can be an ideal regime of operation. See also FIG. 10 for additional simulation.

In FIG. 8, the acoustic wave is driven very strongly, the absorption due to the optical absorption can be made to disappear completely near the center wavelength, e.g. achieve near-zero transmission loss. At the same time, a backward propagating signal only experiences strong optical absorption by the optical mode (due to the intrinsic non-reciprocity). In this regime the process is linear, e.g. the non-reciprocity is not generated through frequency shift of the input light and thus does not need filtering. When this system is brought to critical coupling, many 10's of dB of optical isolation can be achieved over several MHz-GHz bandwidth. The observed optical isolation is a classical wave interference effect caused entirely by the mutual coupling between the three fields.

Fundamental limits imposed by the coupling of forward and backward propagating optical fields through ‘parasitic’ processes can be described, such as Rayleigh scattering. The system and method can rely on unidirectionally co-propagating optical and acoustic fields whose interaction leads to the measured non-reciprocal effects (FIG. 6 and FIG. 7). Even though a backward propagating optical ‘control’ field is not provided, Rayleigh scattering from intrinsic defects on the resonator can generate a backward field. This is the cause of the doublet optical modes seen in ultra-high-Q silica resonators.

The non-reciprocity in this system manifests as a lack of interaction for an optical input propagating opposite to the optical control field. However, optical fields circulating in the forward and backward directions can be coupled by Rayleigh scattering of photons from surface or material variations in the resonator. This can limit the isolation efficiency as it generates an interaction even for backward propagating optical fields.

For modeling purposes, such scattering can be added to the system of equations that describe the triply-resonant system. In particular, two sets of equations can be established that relate the forward fields α₁, α₂, and u, to the backward propagating fields α₁ and α₂,

$${\dot{a}}_{1} = - {γ}_{1} {a}_{1} + i \frac{{γ}_{B}}{2} {a}_{{1}^{′}} - i {β}^{*} {u}^{*} {a}_{2} \\ {\dot{a}}_{{1}^{′}} = - {γ}_{1} {a}_{{1}^{′}} + i \frac{{γ}_{R}}{2} {a}_{1} \\ {\dot{a}}_{2} = - {γ}_{2} {a}_{2} + i \frac{{γ}_{R}}{2} {a}_{{2}^{′}} - i β u {a}_{1} + {f}_{ForwardOpticalProbe} \\ {\dot{a}}_{{2}^{′}} = - {γ}_{2} {a}_{{2}^{′}} + i \frac{{γ}_{R}}{2} {a}_{2} + {f}_{BackwardProbe} \\ \dot{u} = - {γ}_{B} u - i {β}^{*} {a}_{1}^{*} {a}_{2} + {f}_{AcousticDrive} \qquad ( 4 )$$

Here, additional terms have been introduced that incorporate γ_{R} which is the photon coupling rate between forward and backward propagation directions. Assume there is no backward propagating acoustic field u′ since any acoustic wave in the backward direction is not intentionally actuated. The effect of an additional backward acoustic wave that may be excited through analogous phonon scattering processes within the resonator should also be considered. The dynamics of this system can be relevant due to the strong Rayleigh scattering present in high-Q resonators, and impose limitations on the efficiency and practicality of the non-reciprocal systems.

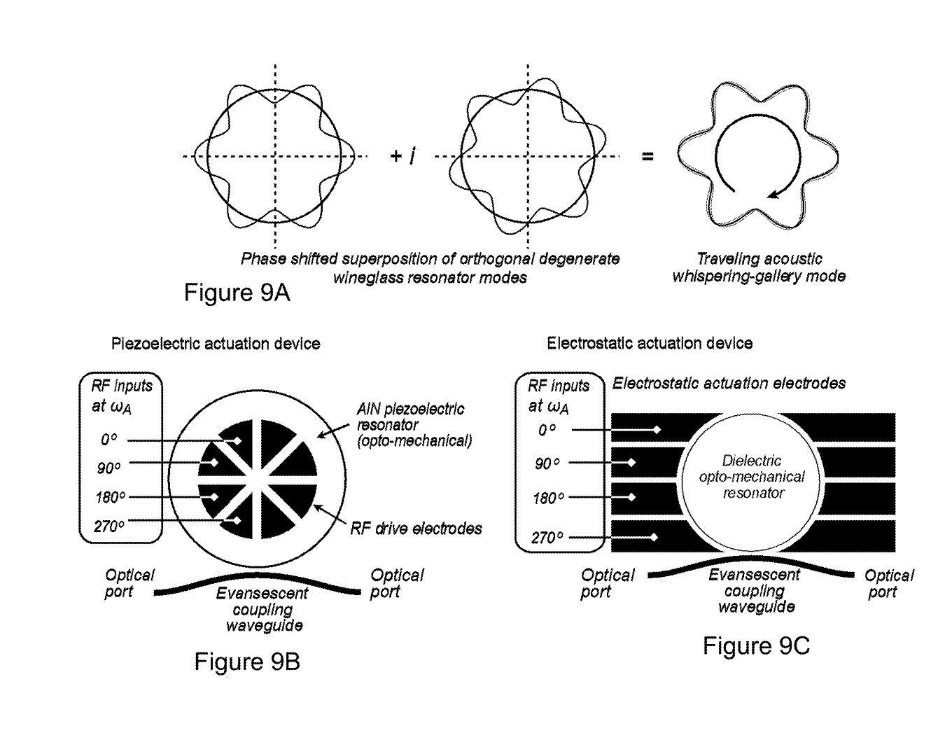

To implement this system, an electro-opto-mechanical resonator can be fabricated having two optical modes and one acoustic mode satisfying the triply-resonant phase matching requirement (this momentum and energy conservation condition was described previously in FIG. 3A). Example systems are illustrated in FIG. 9B and FIG. 9c. Electro-mechanical transduction can be employed for actuating the traveling wave whispering-gallery acoustic mode of the resonator, with the actuation signal provided through a frequency-tunable RF source. As described in FIG. 8, forward propagating optical fields aligned to the lower optical mode can experience the triply-resonant interaction while backward propagating optical fields do not.

FIGS. 9A-C are diagrams of example electro-opto-mechanical resonator systems. In FIG. 9A a unidirectional traveling acoustic wave whispering-gallery mode (FIG. 3A-F) is the sum of two orthogonal phase-shifted degenerate acoustic wineglass modes. In FIG. 9B, example piezoelectric architecture, and FIG. 9C example electrostatic architecture, show the phase-synchronized RF actuation electrodes that can launch the traveling acoustic wave. Note that not all device electrode connections are shown and a very low order electrode configuration is illustrated. To demonstrate optical isolation a high-order (>12 wavelengths around the circumference) acoustic mode can be generated for a greater momentum shift. Light can be evanescently coupled through waveguides or other couplers.

The electro-opto-mechanical resonator device can include (1) low loss optical material for high-Q optical whispering-gallery resonances, (2) high-Q acoustic whispering-gallery resonance phase-matched to the optical resonances, (3) efficient electromechanical transduction. Two versions of the system can include a piezoelectric design and an electrostatic actuator design (see FIG. 9B and C). The materials selection process can be guided by a figure of merit parameter, based on the material acoustic and optical properties.

Acoustic mode actuation: The MEMS field has established techniques for the actuation of wineglass mode mechanical resonators. The traveling wave acoustic whispering-gallery mode is simply the phase-shifted superposition of two high-order wineglass modes (FIG. 9A). Integrated electrodes can be used to launch unidirectional resonant acoustic waves by means of piezoelectric actuation with synchronized phase-shifted RF stimulus. By means of actuation with synchronized phase-shifted RF stimulus, such traveling wave modes can be actuated. More elaborate acoustic excitation patterns can provide nonreciprocal effects at multiple optical modes and wavelengths, or more complex nonreciprocal behaviors.

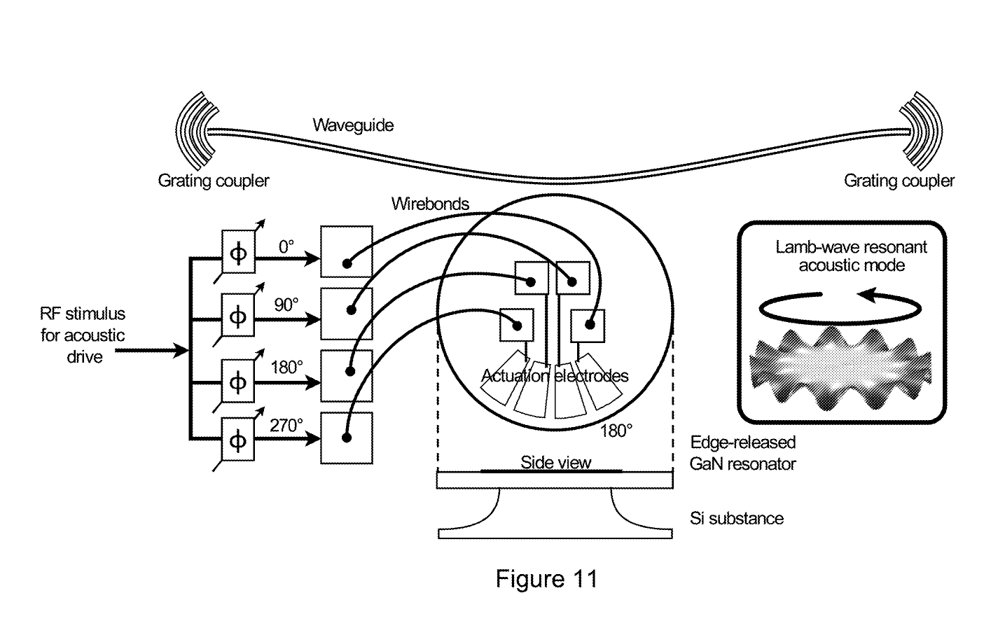

Optical interface: An integrated waveguide can be used to couple the optical signals to the modes of the resonator. The integrated waveguide can be interfaced to off-chip lasers and photodetectors through grating couplers and a standardized V-groove fiber assembly or other coupler (for example, FIG. 11).

The triply-resonant phase matched system of modes can be verified in the device, and acoustic actuation can be employed to demonstrate an optical isolator in the telecom band. Supporting circuitry can apply the phase-shifted electronic inputs. Initially, MEMS actuator functionality can be verified by electronic pickoff as well. When the acoustic mode is driven with a strong stimulus (FIG. 9A-C), a large optical isolation effect is predicted as shown by calculations (FIG. 8). As discussed above, this broad bandwidth isolation can be made possible due to the inherent symmetry of the system equations for BSIT.

Verification tasks: The existence of phase matching can be verified by repeating the BSIT example with the devices developed. In the absence of an acoustic drive the non-reciprocal effect can be optically controlled through a photon pump and probe experiment and can be employed to verify the phase matching. Design iterations can ‘dial in’ the phase matching condition for this process, to optimize the phase matching and the resonator geometry. Once the relevant physical properties of the thin-film materials are determined, a design can be finalized.

Bandwidth and linearity: The optically controlled isolation bandwidth can be verified with a 200 kHz linewidth tunable 1520 nm-1570 nm laser. The optical spectrum can also be verified with the help of a Fabry-Perot optical spectrum analyzer. The examples can be used to determine if under a strong acoustic stimulus the linear regime of operation has been reached (FIG. 8). In that regime, light propagating in the forward direction does not couple to the resonator.

FIG. 10 is a block diagram of an example circulator configuration. By adding a second waveguide to the system, operation as a circulator can be achieved. Forward propagating light (Top-left) does not interact in the acoustic drive case because of the strong triple-mode interference described previously in FIG. 8. In the backward direction (Top-right) the device behaves like a ‘channel dropping filter’. The formalism shown before is extended (Middle-bottom) to simulate the line-center power transfer curves of this configuration. With little to no acoustic drive, all power from port 1 goes to port 4 (e.g. channel dropping filter). With very strong acoustic drive, we enter the linear non-reciprocal regime where resonant interference decouples the top waveguide from the resonator in the forward direction.

A circulator is a 3-port device in which light entering Port 1 exits through Port 2, but returned light entering Port 2 exits through a different Port 3. These devices are available in microwave systems, for instance for RADAR applications, where a single antenna performs both transmit and receive functions. Circulators are integral to such systems where back-reflections or back-scattering is measured. Within the RADAR context, a LIDAR (Light based radar) analogy can also be made. In the context of on-chip communications, a single waveguide can be used for both transmitting and receiving data, which necessitates the switchable routing of forward propagating and backward propagating signals along different paths. Circulators are an important non-reciprocal component and the acousto-optic approach can be used with them.

When the isolator has been demonstrated, a second ‘drop’ waveguide can be added for using the system as a 3 (or 4, etc.) port device. Based on the equations and analysis we show earlier, such a dual waveguide system can result in a circulator. FIG. 10 shows the design and operation of this device along with simulated power transfer curves. When there is no acoustic wave, the system acts as a channel dropping filter. However, when a strong acoustic drive is applied, the system behaves non-reciprocally. A non-symmetric scattering matrix (FIG. 10) is expected in the case of a strong acoustic drive source.

A compact and low power non-reciprocal device can be used for optical isolation for the laser source in a chip-scale atomic clock, or a cold-atom gyroscope, which are applications where spurious magnetic fields may be undesirable. Furthermore, acousto-optic non-reciprocity offers a relatively low-complexity system that can be adapted to any wavelength, operates in nearly all optically transparent materials, and does not require any specialized magnetic materials (or garnets) to be integrated on-chip. Such a technology can also meet cost reduction and complexity reduction objectives in the long term e.g., low-cost optical computation. Nonreciprocity of Brillouin scattering can be used to provide an acoustically controlled optical isolator or circulator that can be designed for any optical wavelength of interest. Controllable non-reciprocity can be used for on-chip optical isolation, optical switching, and rotation sensing applications. Finally, controllable non-reciprocity may also be important for compact transmit and receive functionality in LIDAR systems deployed in UAVs and ultra-light aerial robots.

The systems and methods can have applications in helping make low-cost optical computation much more accessible. For on-chip optical communications and signal processing, a single waveguide may be used to both transmit and receive information, necessitating an optical circulator. The switchable characteristic of the systems, e.g., on and off, can also enable both photon-controlled and phonon-controlled optical signal routing. Demonstrating Brillouin transparency: BSIT can be demonstrated in a silica microsphere resonator by measuring these phase-matched optical modes through a pump-probe experiment. In general, an optical field interacting with a mode of a resonator experiences very strong absorption within the optical resonance bandwidth (FIG. 7). However, the presence of a strong optical pump on the low-frequency optical mode induces a transparency for the higher-frequency probe mode due to the Brillouin interaction. In other words, the probe signal absorption is inhibited, resulting in greater transmission through the otherwise absorbing optical mode (FIG. 7).

Nonreciprocal transparency: co-propagation of the three waves satisfies the phase matching conditions (FIG. 6). If the secondary probe laser field propagates in the backward direction, phase matching with the specific acoustic wave is not satisfied and no interaction takes place. This leads to a direction-dependent nonreciprocity as demonstrated in FIG. 7. Such nonreciprocity is unavailable in any other optomechanical system till date. Magnet-free isolation by using traveling wave light-sound interactions has proven challenging to implement on-chip due to low efficiency, and high power and device length requirements.

A whispering gallery resonator permits the Brillouin scattering interaction with optical and acoustic fields that are only propagating in one direction (e.g., is a reflectionless system). In contrast, the interaction within a Fabry-Perot resonator or a conventional MEMS resonator, is reciprocal. This is because the back-and-forth reflections cause the fields to propagate in both forward and backward, e.g. produce standing waves, thereby nullifying the nonreciprocal effect. A second advantage is the existence of discrete MHz-linewidth optical resonances in WGRs, which permit the asymmetric scattering shown in FIG. 6. In contrast to a finite length waveguide in which the Brillouin interaction can be supported in a WGR the length over which light and sound interact is effectively infinite and is limited only by the lifetime of the photons and phonons. High-Q resonance enhancement also provides an input power advantage for achieving isolation.

The above-described can be used for any wave phenomenon, e.g., radio frequency, microwaves, light, sound, gravity, and other wave phenomenon, etc.

The systems, methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits.

Many modifications and other embodiments set forth herein can come to mind to one skilled in the art having the benefit of the teachings presented in the foregoing descriptions and the associated drawings. Although specified terms are employed herein, they are used in a generic and descriptive sense only and not for purposes of limitation.

1. A system, comprising:
a waveguide for guiding a signal wave;
a resonator coupled with the waveguide; and
a signal generator to produce a spatiotemporal pattern wave on the resonator;
where a wave interaction between the signal wave and the spatiotemporal pattern wave within the resonator produce linear non-reciprocal behavior for the signal wave in the waveguide.

2. The system of claim 1, where the signal wave comprises at least one of an optical input, a sound wave, a microwave and a radio frequency.

3. The system of claim 1, where the waveguide comprises at least one of a dielectric, a microstrip and a tapered optical fiber.

4. The system of claim 1, where the resonator comprises a whispering gallery resonator.

5. The system of claim 4, where the whispering gallery generator supports resonant modes that allow Brillouin scattering.

6. The system of claim 1, where the signal generator comprises at least one of an optical pump to produce an optical wave and an acoustic pump to produce an acoustic wave.

7. The system of claim 1, where the wave interaction results in at least one of an isolator and a circulator.

8. The system of claim 7, where the isolator is non-magnetic.

9. The system of claim 1, where the signal generator is switchable on and off.

10. The system of claim 1, where the wave interaction comprises at least one of a light wave and a sound wave.

11. The system of claim 1, where a material of the waveguide comprises glass.

12. The system of claim 1, where the signal wave is received from at least one of a speaker and a laser.

13. A method, comprising:
Brillouin scattering coupling an input with a first wave and a second wave to produce a linear non-reciprocal behavior in the optical input.

14. The method of claim 13, where energy and momentum are matched between the input, the first wave and the second wave.

15. The method of claim 13, where the coupling is at least one of optically and acoustically switchable.

16. The method of claim 13, where the first wave comprises a sound wave and the second wave comprises a light wave.

17. The method of claim 13, where the first wave comprises a light wave and the second wave comprises a sound wave.

18. The method of claim 13, where the first wave comprises a light wave and the second wave comprises a light wave.

19. The method of claim 13, where the input comprises at least one of a radio frequency wave, a microwave, light, sound, and a gravity wave.
